(19) United States
(12) Patent Application Publication
(10) Pub. No.: US 2010/0152412 A1
(43) Pub. Date: Jun. 17, 2010

(54) REDUCTION OF WHITENING OF POLY(TRIMETHYLENE TEREPHTHALATE) PARTS BY SOLVENT EXPOSURE

(75) Inventors: BRETT COLLIN DOBRICK, WILMINGTON, DE (US); BENJAMIN WEAVER MESSMORE, WILMINGTON, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/639,250

(22) Filed: Dec. 16, 2009

Related U.S. Application Data
(60) Provisional application No. 61/138,307, filed on Dec. 17, 2008.

(51) Int. Cl. C08G 63/123

(52) U.S. Cl. 528/308.6

(57) ABSTRACT

This invention relates to a process for producing non-whitening molded parts of poly(trimethylene terephthalate) (PTT) with reduced whitening after an elevated temperature aging test by exposing the parts to solvents.

### FIELD OF THE INVENTION

This invention relates to a process for producing non-whitening molded parts of poly(trimethylene terephthalate) (PTT) with reduced whitening after an elevated temperature aging test by exposing the parts to solvents.

### BACKGROUND

The phenomenon of “blooming” is a common problem for polymeric materials. Incompatible materials added to polymers can migrate to the surface of the part, causing a “bloom” or “haze.” These defects have a negative effect on the cosmetic appearance of the material and sometimes can impact performance of the material. In polyester technology, blooming is a well researched phenomenon in polyester films and fibers, namely polyethylene terephthalate (PET) and polytrimethylene terephthalate (PTT). In the case of these polyesters the bloom is not an additive, but thermodynamic by-products of step polymerizations: cyclic oligomers.

Cyclic oligomers exist at equilibrium during the melt polymerization process of polyesters. During the polymerization process, hydroxyl end groups back-bite onto the main polymer chain to form cyclic species. The melt equilibrium of cyclic oligomers in PTT is higher than the melt equilibrium of cyclic oligomers in PET or PBT. The most abundant cyclic oligomer of PTT, PTT cyclic dimer, exists at an equilibrium concentration of 2.5 wt. %. During elevated temperature aging tests, cyclic oligomers of PTT are known to bloom to the surface of molded parts.

Therefore, there is a need for a process for producing non-whitening molded parts of polymers, such as PTT. The present invention fulfills such a need.

### SUMMARY OF THE INVENTION

The invention is directed to a process for treating polymeric articles, comprising exposing the articles to one or more solvents, wherein the whiteness of the articles is decreased by at least 10 percent from the original value, based on L* values recorded after an elevated temperature aging test.

### BRIEF DESCRIPTION OF THE DRAWINGS

FIG. 1 is a representation of the whitening of black parts (L values recorded at 110° from the specular beam (see U.S. Pat. No. 4,479,718)) of solvent treated plaques aged at 145° C. for 24 hours (elevated temperature aging test) plotted as a function of acceptor number of the solvents in which the parts were exposed to for five minutes at room temperature.

### DETAILED DESCRIPTION

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Unless otherwise stated, all percentages, parts, ratios, etc., are by weight.

Polymer Component

As indicated herein, the polymer component (and composition as a whole) comprises a predominant amount of a poly(trimethylene terephthalate).

Poly(trimethylene terephthalate) suitable for use in the invention are well known in the art, and conveniently prepared by polycondensation of 1,3-propane diol with terephthalic acid or terephthalic acid equivalent.

By “terephthalic acid equivalent” is meant compounds that perform substantially like terephthalic acids in reaction with polymeric glycols and diols, as would be generally recognized by a person of ordinary skill in the relevant art. Terephthalic acid equivalents for the purpose of the present invention include, for example, esters (such as dimethyl terephthalate), and ester-forming derivatives such as acid halides (e.g., acid chlorides) and anhydrides.

Preferred are terephthalic acid and terephthalic acid esters, more preferably the dimethyl ester. Methods for preparation of poly(trimethylene terephthalate) are discussed, for example in U.S. Pat. No. 6,277,947, U.S. Pat. No. 6,326,456, U.S. Pat. No. 6,657,044, U.S. Pat. No. 6,353,062, U.S. Pat. No. 6,538,076, US2003/0220465A1 and commonly owned U.S. patent application Ser. No. 11/638,919 (filed 14 Dec. 2006, entitled “Continuous Process for Producing Poly(trimethylene Terephthalate)”) which are all incorporated by reference.

The 1,3-propanediol for use in making the poly(trimethylene terephthalate) is preferably obtained biochemically from a renewable source (“biologically-derived” 1,3-propanediol).

A particularly preferred source of 1,3-propanediol is via a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several publications U.S. Pat. No. 5,633,362, U.S. Pat. No. 5,686,276 and U.S. Pat. No. 5,821,092 which are all incorporated by reference. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol preferred for use in the context of the present invention contains renewable carbon. Other sources, such as fossil fuel-based or petroleum-based carbon or mixtures thereof may be used but are not preferred sources of 1,3-propanediol. The polytrimethylene terephthalate based thereon utilizing the biologically-derived 1,3-propanediol, therefore, has less impact on the environment and does not deplete diminishing fossil fuels and, upon degradation, releases carbon back to the atmosphere for use by plants once again. Thus, the compositions of the present invention can be characterized as more natural and having less environmental impact than similar compositions comprising petroleum based diols.

The biologically-derived 1,3-propanediol, and polytrimethylene terephthalate based thereon, may be distinguished from similar compounds produced from a petrochemical source or from fossil fuel carbon by dual carbon-isotopic finger printing. This method usefully distinguishes chemically-identical materials, and apportions carbon material by source (and possibly year) of growth of the biospheric (plant) component. The isotopes, ¹⁴C and ¹³C, bring complementary information to this problem. The radiocarbon dating isotope (¹⁴C), with its nuclear half life of 5730 years, clearly allows one to apportion specimen carbon between fossil (“dead”) and biospheric (“alive”) feedstocks (Currie, L. A. “Source Apportionment of Atmospheric Particles,” Characterization of Environmental Particles, J. Buffle and H. P. van Leeuwen, Eds., 1 of Vol. I of the IUPAC Environmental Analytical Chemistry Series (Lewis Publishers, Inc) (1992) 3-74). The basic assumption in radiocarbon dating is that the constancy of ¹⁴C concentration in the atmosphere leads to the constancy of ¹⁴C in living organisms. When dealing with an isolated sample, the age of a sample can be deduced approximately by the relationship:

t=(−5730/0.693)ln(A/A₀)

wherein t=age, 5730 years is the half-life of radiocarbon, and A and A₀ are the specific ¹⁴C activity of the sample and of the modern standard, respectively (Hsieh, Y., Soil Sci. Soc. Am J., 56, 460, (1992)). However, because of atmospheric nuclear testing since 1950 and the burning of fossil fuel since 1850, ¹⁴C has acquired a second, geochemical time characteristic. Its concentration in atmospheric CO₂, and hence in the living biosphere, approximately doubled at the peak of nuclear testing, in the mid-1960s. It has since been gradually returning to the steady-state cosmogenic (atmospheric) baseline isotope rate (¹⁴C/¹²C) of ca. 1.2×10⁻¹², with an approximate relaxation “half-life” of 7-10 years. (This latter half-life must not be taken literally; rather, one must use the detailed atmospheric nuclear input/decay function to trace the variation of atmospheric and biospheric ¹⁴C since the onset of the nuclear age. It is this latter biospheric ¹⁴C time characteristic that holds out the promise of annual dating of recent biospheric carbon. ¹⁴C can be measured by accelerator mass spectrometry (AMS), with results given in units of “fraction of modern carbon” (f_{M}). f_{M} is defined by National Institute of Standards and Technology (NIST) Standard Reference Materials (SRMs) 4990B and 4990C, known as oxalic acids standards HOxI and HOxII, respectively. The fundamental definition relates to 0.95 times the ¹⁴C/¹²C isotope ratio HOxI (referenced to AD 1950). This is roughly equivalent to decay-corrected pre-Industrial Revolution wood. For the current living biosphere (plant material) f_{M}≈1.1.

The stable carbon isotope ratio (¹³C/¹²C) provides a complementary route to source discrimination and apportionment. The ¹³C/¹²C ratio in a given biosourced material is a consequence of the ¹³C/¹²C ratio in atmospheric carbon dioxide at the time the carbon dioxide is fixed and also reflects the precise metabolic pathway. Regional variations also occur. Petroleum, C₃ plants (the broadleaf), C₄ plants (the grasses), and marine carbonates all show significant differences in ¹³C/¹²C and the corresponding δ ¹³C values. Furthermore, lipid matter of C₃ and C₄ plants analyze differently than materials derived from the carbohydrate components of the same plants as a consequence of the metabolic pathway. Within the precision of measurement, ¹³C shows large variations due to isotopic fractionation effects, the most significant of which for the instant invention is the photosynthetic mechanism. The major cause of differences in the carbon isotope ratio in plants is closely associated with differences in the pathway of photosynthetic carbon metabolism in the plants, particularly the reaction occurring during the primary carboxylation, i.e., the initial fixation of atmospheric CO₂. Two large classes of vegetation are those that incorporate the “C₃” (or Calvin-Benson) photosynthetic cycle and those that incorporate the “C₄” (or Hatch-Slack) photosynthetic cycle. C₃ plants, such as hardwoods and conifers, are dominant in the temperate climate zones. In C₃ plants, the primary CO₂ fixation or carboxylation reaction involves the enzyme ribulose-1,5-diphosphate carboxylase and the first stable product is a 3-carbon compound. C₄ plants, on the other hand, include such plants as tropical grasses, corn and sugar cane. In C₄ plants, an additional carboxylation reaction involving another enzyme, phosphenol-pyruvate carboxylase, is the primary carboxylation reaction. The first stable carbon compound is a 4-carbon acid, which is subsequently decarboxylated. The CO₂ thus released is refixed by the C₃ cycle.

Both C₄ and C₃ plants exhibit a range of ¹³C/¹²C isotopic ratios, but typical values are ca. −10 to −14 per mil (C₄) and −21 to −26 per mil (C₃) (Weber et al., J. Agric. Food Chem., 45, 2042 (1997)). Coal and petroleum fall generally in this latter range. The ¹³C measurement scale was originally defined by a zero set by pee dee belemnite (PDB) limestone, where values are given in parts per thousand deviations from this material. The “δ¹³C” values are in parts per thousand (per mil), abbreviated ‰, and are calculated as follows:

$${δ}^{13} C ≡ \frac{( {}^{13} C / {}^{12} C ) sample - ( {}^{13} C / {}^{12} C ) standard}{( {}^{13} C / {}^{12} C ) standard} \times {1000}^{0 {/}_{00}}$$

Since the PDB reference material (RM) has been exhausted, a series of alternative RMs have been developed in cooperation with the IAEA, USGS, NIST, and other selected international isotope laboratories. Notations for the per mil deviations from PDB is δ¹³C. Measurements are made on CO₂ by high precision stable ratio mass spectrometry (IRMS) on molecular ions of masses 44, 45 and 46.

Biologically-derived 1,3-propanediol, and compositions comprising biologically-derived 1,3-propanediol, therefore, may be completely distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Preferably the 1,3-propanediol used as a reactant or as a component of the reactant in making poly(trimethylene terephthalate) will have a purity of greater than about 99%, and more preferably greater than about 99.9%, by weight as determined by gas chromatographic analysis. Particularly preferred are the purified 1,3-propanediols as disclosed in U.S. Pat. No. 7,038,092, U.S. Pat. No. 7,098,368, U.S. Pat. No. 7,084,311 and US20050069997A1 which are incorporated by reference.

The purified 1,3-propanediol preferably has the following characteristics:

(1) an ultraviolet absorption at 220 nm of less than about 0.200, and at 250 nm of less than about 0.075, and at 275 nm of less than about 0.075; and/or

(2) a composition having a CIELAB “b*” color value of less than about 0.15 (ASTM D6290), and an absorbance at 270 nm of less than about 0.075; and/or

(3) a peroxide composition of less than about 10 ppm; and/or

(4) a concentration of total organic impurities (organic compounds other than 1,3-propanediol) of less than about 400 ppm, more preferably less than about 300 ppm, and still more preferably less than about 150 ppm, as measured by gas chromatography.

Poly(trimethylene terephthalate)s useful in this invention can be poly(trimethylene terephthalate) homopolymers (derived substantially from 1,3-propane diol and terephthalic acid and/or equivalent) and copolymers, by themselves or in blends. Poly(trimethylene terephthalate)s used in the invention preferably contain about 70 mole % or more of repeat units derived from 1,3-propane diol and terephthalic acid (and/or an equivalent thereof, such as dimethyl terephthalate).

The poly(trimethylene terephthalate) may contain up to 30 mole % of repeat units made from other diols or diacids. The other diacids include, for example, isophthalic acid, 1,4-cyclohexane dicarboxylic acid, 2,6-naphthalene dicarboxylic acid, 1,3-cyclohexane dicarboxylic acid, succinic acid, glutaric acid, adipic acid, sebacic acid, 1,12-dodecane dioic acid, and the derivatives thereof such as the dimethyl, diethyl, or dipropyl esters of these dicarboxylic acids. The other diols include ethylene glycol, 1,4-butane diol, 1,2-propanediol, diethylene glycol, triethylene glycol, 1,3-butane diol, 1,5-pentane diol, 1,6-hexane diol, 1,2-, 1,3- and 1,4-cyclohexane dimethanol, and the longer chain diols and polyols made by the reaction product of diols or polyols with alkylene oxides.

Poly(trimethylene terephthalate) polymers useful in the present invention may also include functional monomers, for example, up to about 5 mole % of sulfonate compounds useful for imparting cationic dyeability. Specific examples of preferred sulfonate compounds include 5-lithium sulfoisophthalate, 5-sodium sulfoisophthalate, 5-potassium sulfoisophthalate, 4-sodium sulfo-2,6-naphthalenedicarboxylate, tetramethylphosphonium 3,5-dicarboxybenzene sulfonate, tetrabutylphosphonium 3,5-dicarboxybenzene sulfonate, tributyl-methylphosphonium 3,5-dicarboxybenzene sulfonate, tetrabutylphosphonium 2,6-dicarboxynaphthalene-4-sulfonate, tetramethylphosphonium 2,6-dicarboxynapthalene-4-sulfonate, ammonium 3,5-dicarboxybenzene sulfonate, and ester derivatives thereof such as methyl, dimethyl, and the like.

More preferably, the poly(trimethylene terephthalate)s contain at least about 80 mole %, or at least about 90 mole %, or at least about 95 mole %, or at least about 99 mole %, of repeat units derived from 1,3-propane diol and terephthalic acid (or equivalent). The most preferred polymer is poly(trimethylene terephthalate) homopolymer (polymer of substantially only 1,3-propane diol and terephthalic acid or equivalent).

The polymer component may contain other polymers blended with the poly(trimethylene terephthalate) such as poly(ethylene terephthalate) (PET), poly(butylene terephthalate) (PBT), a nylon such nylon-6 and/or nylon-6,6, etc., and preferably contains at least about 70 wt %, or at least about 80 wt %, or at least about 90 wt %, or at least about 95 wt %, or at least about 99 wt %, poly(trimethylene terephthalate) based on the weight of the polymer component. In one preferred embodiment, the polyester polymer comprises 90-100 wt % of poly(trimethylene terephthalate) polyester.

The poly(trimethylene terephthalate) polymer may contain inorganic fillers, including glass fiber or clays. The blooming phenomenon also occurs in glass fiber reinforced compositions, and the approach to reduce whitening discussed herein can be applied successfully for these compositions. Reinforced poly(trimethylene terephthalate) compositions can contain from 15-45% glass fiber reinforcement.

### Additive Package

The poly(trimethylene terephthalate)-based compositions of the present invention may contain additives such as antioxidants, residual catalyst, delusterants (such as TiO₂, zinc sulfide or zinc oxide), colorants (such as dyes), stabilizers, fillers (such as calcium carbonate), antimicrobial agents, antistatic agents, optical brighteners, extenders, processing aids and other functional additives, hereinafter referred to as “chip additives”. When used, TiO₂ or similar compounds (such as zinc sulfide and zinc oxide) are used as pigments or delusterants in amounts normally used in making poly(trimethylene terephthalate) compositions, that is up to about 5 wt % or more (based on total composition weight) in making fibers and larger amounts in some other end uses.

By “pigment” reference is made to those substances commonly referred to as pigments in the art. Pigments are substances, usually in the form of a dry powder, that impart color to the polymer or article (e.g., chip or fiber). Pigments can be inorganic or organic, and can be natural or synthetic. Generally, pigments are inert (e.g., electronically neutral and do not react with the polymer) and are insoluble or relatively insoluble in the medium to which they are added, in this case the poly(trimethylene terephthalate) composition. In some instances they can be soluble.

Low concentrations of additives (0-5%) have not been found to positively impact part whitening. Part whitening has also been observed in glass reinforced parts. The methods covered in the present disclosure can be applied to PTT parts containing these additive packages.

The poly(trimethylene terephthalate)-based compositions of the invention may be prepared by conventional blending techniques well known to those skilled in the art, e.g. compounding in a polymer extruder, melt blending, etc.

The polymer component and additive(s) can be melt blended. More specifically, they can be mixed and heated at a temperature sufficient to form a melt blend, and formed into shaped articles. The ingredients can be formed into a blended composition in many different ways. For instance, they can be (a) heated and mixed simultaneously, (b) pre-mixed in a separate apparatus before heating, or (c) heated and then mixed. The mixing, heating and forming can be carried out by conventional equipment designed for that purpose such as extruders, Banbury mixers or the like. The temperature should be above the melting points of each component but below the lowest decomposition temperature, and accordingly must be adjusted for any particular composition of PTT and flame retardant additive. The temperature is typically in the range of about 180° C. to about 300° C.

Poly(trimethylene terephthalate)s useful as the polyester in this invention are commercially available from E. I. DuPont de Nemours and Company of Wilmington, Del. under the trademark Sorona® and from Shell Chemicals of Houston, Tex. under the trademark Corterra®.

In one preferred embodiment of this invention, polyester molded parts are dipped into a vessel containing solvent or carried into a vessel containing solvent similar to the electrocoating process.

In another preferred embodiment of this invention, polyester molded parts are dumped into a fixed bed leacher.

In another preferred embodiment of this invention, polyester molded parts are put into a counter-current leach system similar to a Bollman bucket.

In another preferred embodiment of this invention, polyester molded parts are sprayed using a nozzle similar to a high pressure solvent delivery device.

In the present invention, polymeric parts, preferably poly(trimethylene terephthalate) parts are exposed to various solvents under various conditions. The conditions include residence time of about 5 seconds to 1 hour and temperature from about 21 C to 150 C, preferably 21 C to 100 C. Solvents are often classified by their electrophilic properties. A quantitative empirical parameter to describe the elecrophilic properties of solvents is acceptor number as discussed in Mayer et al., Monatshefte fur Chemie 106, 1235-1257 (1975). Preferred acceptor numbers include about 0-43, and are shown in Table 1 for the solvents used in the embodiments of the invention herein. These parameters were useful to correlate the effectiveness of the solvent to reduce the whitening observed in PTT parts. While any solvent can be used to reduce the observed whitening, toluene, ethyl acetate, chloroform, cichloromethane, and ethanol are preferred.

### Example

Injection molded articles of PTT were prepared by compounding 97.7% PTT (Sorona® polymer) 2.3 weight % carbon black masterbatch (52.5 weight % polyethylene carrier, 47.5 weight % carbon black) and molding to afford unreinforced black parts. PTT polymer was extruded at 250° C. into a 100° C. mold. 3×5×⅛ inch rectangular plaques were molded. Plaques were dipped in a beaker containing 800 mL solvent for a specific amount of time. If no solvent is listed, the sample was not dipped in any solvent. Examples are listed in Table 1.

Plaques were then evaluated for blooming using an elevated temperature aging test. For this test, plaques were wrapped in aluminum foil and placed in aluminum pans to provide uniform heating throughout the part. The wrapped plaques in aluminum pans were placed in a closed oven (no vacuum/purge) for twenty four hours at 145° C. Part blooming can be observed over a range of temperatures, but we found 145° C. for 24 hours to be good conditions to observe the oligomer bloom as it was shown to be repeatable and reproducible and gave results relatively quickly. Part blooming was quantified using a DuPont Color Solutions X-Rite L*a*b* colorimeter since the white cyclic oligomer bloom covers the surface of a black part. The smaller the amount of cyclic oligomer is on the surface, the more the carbon black pigment can be observed by incident light. Observations made for the L value on the 110° angle gave a quantitative measure of blooming that agrees well with a visual rating system. Low L values (3-5) correspond to a low degree of blooming and higher L values (20-25) correspond to a high degree of blooming. The results of the elevated temperature aging test are detailed in Table 1.

TABLE 1

| | | | | | X-Rite L* |
|---|---|---|---|---|---|
| | | | | | Value at 110° |
| | | | | | after |
| | | | Residence Time | | elevated |
| | | Acceptor | in the solvent/ | Temperature of | temperature |
| Ex. # | Solvent | Number* | min | the solvent/° C. | aging test |
| 1 | Comparative | | 5 | 21 | 21 |
| 2 | Dichloromethane | 20.4 | 5 | 21 | 6 |
| 3 | Hexanes | 0 | 5 | 21 | 12 |
| 4 | Methanol | 41.3 | 5 | 21 | 10 |
| 5 | Spray 9 | | 5 | 21 | 12 |
| 6 | Windex | | 5 | 21 | 25 |
| 7 | 1,3 propane diol | 43.7 | 5 | 21 | 16 |
| 8 | 1,2 dichlorobenzene | 10.7 | 5 | 21 | 11 |
| 9 | Acetone | 12.5 | 5 | 21 | 8 |
| 10 | Water | 54.8 | 5 | 21 | 24 |
| 11 | Acetone | 12.5 | 2 | 21 | 7 |
| 12 | Acetone | 12.5 | 10 | 21 | 7 |
| 13 | Acetone | 12.5 | 20 | 21 | 8 |
| 14 | Hexanes | 0 | 2 | 21 | 13 |
| 15 | Hexanes | 0 | 10 | 21 | 10 |
| 16 | Hexanes | 0 | 20 | 21 | 11 |
| 17 | Methanol | 41.3 | 2 | 21 | 9 |
| 18 | Methanol | 41.3 | 10 | 21 | 9 |
| 19 | Methanol | 41.3 | 20 | 21 | 9 |
| 20 | Chloroform | 23.1 | 5 | 21 | 5 |
| 21 | Toluene | 8.2 | 5 | 21 | 5 |
| 22 | Acetonitrile | 18.9 | 5 | 21 | 6 |
| 23 | 1,4 Dioxane | 10.8 | 5 | 21 | 6 |
| 24 | Propylene Carbonate | 19.2 | 5 | 21 | 12 |
| 25 | Ethyl Acetate | 10.5 | 5 | 21 | 7.3 |
| 26 | Ethanol | 37.1 | 5 | 21 | 5 |
| 27 | Diethyl ether | 3.9 | 5 | 21 | 8 |
| 28 | Dimethylformamide | 16 | 5 | 21 | 6 |
| 29 | Dimethylacetamide | 13.6 | 5 | 21 | 5 |
| 30 | Acetic Acid | 52.9 | 5 | 21 | 8 |
| 31 | Ethylene Glycol | 45.6 | 5 | 21 | 11 |
| 32 | Glycerol | 47.7 | 5 | 21 | 20 |
| 33 | Dichloromethane | 20.4 | 2 | 40 | 3 |
| 34 | Dichloromethane | 20.4 | 1 | 40 | 4 |
| 35 | Dichloromethane | 20.4 | 0.5 | 40 | 5 |
| 36 | Dichloromethane | 20.4 | 0.25 | 40 | 6 |
| 37 | Ethylene Glycol | 45.6 | 5 | 40 | 7 |
| 38 | Ethylene Glycol | 45.6 | 5 | 50 | 5 |
| 39 | Ethylene Glycol | 45.6 | 5 | 75 | 4 |
| 40 | Ethylene Glycol | 45.6 | 5 | 100 | 4 |
| 41 | Propylene Carbonate | 19.2 | 5 | 40 | 10 |
| 42 | Propylene Carbonate | 19.2 | 5 | 50 | 6 |
| 43 | Propylene Carbonate | 19.2 | 5 | 75 | 8 |
| 44 | Propylene Carbonate | 19.2 | 5 | 100 | 6 |
| 45 | Water | 54.8 | 5 | 95 | 15 |
| 46 | 5 wt. % SDS in water | | 5 | 95 | 5 |

*Acceptor numbers from Mayer et al., Monatshefte fur Chemie 106, 1235-1257 (1975)

*Acceptor numbers from Mayer et al., Monatshefte fur Chemie 106, 1235-1257 (1975)

### Discussion:

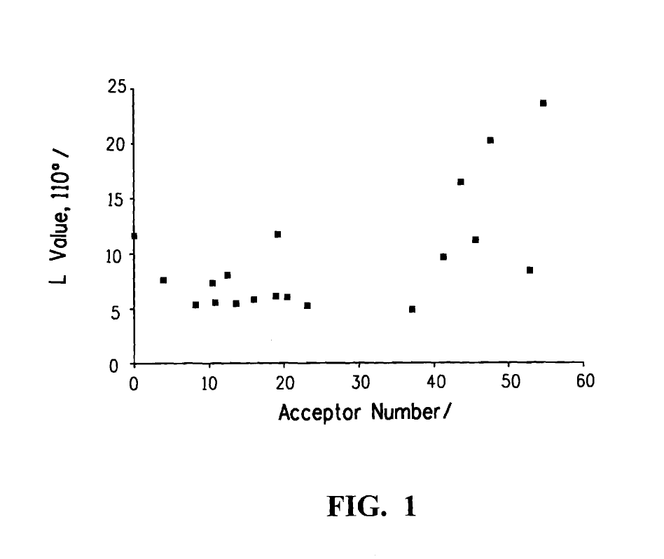

Exposure of PTT plaques to various solvents had an impact on oligomer blooming after an elevated temperature aging test. Some solvents did not perform as well as others to reduce whitening observed after the elevated temperature aging test. If one classifies the solvents by acceptor number and plot the L value recorded at 110° after the elevated temperature aging test, it is apparent that there is a preferable range of solvents that are more effective impacting part whitening. (FIG. 1)

The amount of time the plaque was exposed to solvent and the temperature of the solvent were also important. At 40° C., for example, plaques dipped in dichloromethane for 15 seconds (Example 36) performed similarly to plaques dipped in dichloromethane at room temperature for 5 minutes (Example 2). Plaques dipped for longer periods of time in dichloromethane at 40° C. further enhanced the surface appearance after the elevated temperature aging test.

A relatively poor performing solvent at room temperature, including propylene carbonate (Example 24) or ethylene glycol (Example 31), can be made more effective at reducing whitening with an increase in temperature (Examples 37-40 and Examples 41-44).

The amount of time the plaque resided in the solvent at room temperature (Evaluated for Acetone (Examples 9, 11-13), Hexanes (Examples 3, 14-16) and Methanol (Examples 4, 17-19)) did not impact whitening performance greatly between 2 and 20 minutes.

Finally, in addition to organic solvents, aqueous solutions of surfactants can be employed to impact part whitening. Example 46 details a plaque exposed to a surfactant solution at elevated temperature (95° C.) Compared to Example 45, (water at 95° C.) the surfactant treated plaque performed well.

What is claimed is:

1. A process for treating polymeric articles, comprising exposing the articles to one or more solvents, wherein the whiteness of the articles is decreased by at least 10 percent from the original value, based on L* values recorded after an elevated temperature aging test.

2. The process of claim 1, wherein the articles are comprised of poly(trimethylene terephthalate).

3. The process of claim 1, wherein the solvent has an acceptor number of 0-43.

4. The process of claim 1, wherein the solvent is selected from the group consisting of toluene, ethyl acetate, chloroform, dichloromethane, and ethanol.

5. The process of claim 1 where the solvent is at a temperature of 21° C.-150° C.

6. The process of claim 1, wherein the solvent is a surfactant solution.

7. The process of claim 6 wherein the surfactant solution is at a temperature of 21-100° C.

8. The process of claim 1 wherein the article is exposed to one or more solvents for time periods between about 15 seconds and 1 hour.
